(19) United States
(12) Patent Application Publication
(10) Pub. No.: US 2020/0262554 A1
(43) Pub. Date: Aug. 20, 2020

(54) METHODS AND SYSTEMS FOR WIRELESS POWER TRANSFER FOR ELECTRICALLY POWERED AERIAL VEHICLES

(71) Applicant: Global Energy Transmission, Co., Woodland, WA (US)

(72) Inventors: Sergey PLEKHANOV, Moscow (RU); Leonid PLEKHANOV, Moscow (RU)

(21) Appl. No.: 16/581,559

(22) Filed: Sep. 24, 2019

Related U.S. Application Data
(60) Provisional application No. 62/735,816, filed on Sep. 24, 2018.

(51) Int. Cl. B64C 39/02; B60L 53/126; B60L 53/36; B60L 53/38; B60L 58/12; H02J 50/80; H02J 50/90; H02J 7/00

(52) U.S. Cl. CPC B64C 39/024; B60L 53/126; B60L 53/36; B60L 53/38; B60L 58/12; H02J 2310/44; H02J 50/90; H02J 7/00034; H02J 7/00045; B64C 2201/066; B60L 2200/10; H02J 50/80

(57) ABSTRACT

A method, system, and non-transitory computer-readable medium is provided for enabling a distributed power transfer network for an aerial vehicle, such as a drone. The distributed power transfer network may include wireless power transfer systems that may allow wireless charging and powering of devices within a distance of 10 meters. In some example embodiments, the distributed power transfer system may include at least one transmitter generating at least one transmission signal. The distributed power transfer system may further include a plurality of transducers each conducting a respective transmission signal of the at least one transmission signal, the plurality of transducers being positioned at respective different locations for producing from the respective transmission signals magnetic fields defining associated power transfer regions for transmitting wirelessly with the associated magnetic fields, power to aerial vehicles located in the power transfer regions.

### CROSS-REFERENCE TO RELATED APPLICATIONS

This application claims priority to U.S. Provisional Patent Application Ser. No. 62/735,816, filed Sep. 24, 2018, the disclosure of which is herein incorporated by reference.

### INTRODUCTION

The present invention generally relates to the field of aerial vehicles, and more particularly relates to a method and a system for distributed power transfer for an electrically powered aerial vehicle.

Electrically powered aerial vehicles, which include vertical take-off and landing (VTOL) aerial vehicles or unmanned aerial vehicles (UAVs), such as a drone, can be used for urban air transportation, delivery, monitoring, security, surveillance and rescue operations, and other possible applications. Such aerial vehicles may include a rechargeable battery that needs to be recharged during operation for extending their range of travel. One of the technologies that may be used for providing recharging power to the drones may be wireless power transfer technology. The wireless power transfer may be provided to the drones using a distributed power transfer system.

### SUMMARY

The methods and systems discussed herein may be configured to provide a wireless power transfer system for an electrically powered aerial vehicle, whether manned or unmanned, such as a UAV or a VTOL aerial vehicle. In some example embodiments, the UAV may be a drone. The wireless power transfer system may include at least one transmitter generating at least one transmission signal. The wireless power transfer system may further include a plurality of transducers each conducting a respective transmission signal of the at least one transmission signal, the plurality of transducers being positioned at respective different locations for producing from the respective transmission signals magnetic fields defining associated power transfer regions for transmitting wirelessly with the associated magnetic fields, power to the aerial vehicle located in the power transfer regions.

In some example embodiments, at least two of the power transfer regions may be spaced apart from each other. In some example embodiments, the spacing may be at least one kilometer apart.

In some example embodiments, at least three of the power transfer regions may be spaced apart from each other. The at least three power transfer regions may be distributed to form a two-dimensional grid of power transfer regions.

In some example embodiments, at least two of the power transfer regions may overlap forming an extended power transfer region.

In some example embodiments, a chain of at least three of the power transfer regions may overlap end to end to form the extended power transfer region as a linear extended power transfer region.

In some example embodiments, the wireless power transfer system may further comprise a management unit maintaining information regarding operation and use of the power transfer regions, and wherein each of the at least one transmitter includes a communication unit configured to communicate with the management unit and with the aerial vehicles located in the associated one or more of the power transfer regions having magnetic fields produced by the respective transmission signals generated by the transmitter.

In some example embodiments, the wireless power transfer system may be configured to receive from each aerial vehicle, associated indicia identifying the aerial vehicle and communicate the received indicia identifying the aerial vehicle to the management unit. In some example embodiments, the management unit may be configured to determine whether the identifying indicia is included in a list of identifying indicia for power receivers authorized to receive power in the power transfer region.

In some example embodiments, the wireless power transfer system may include the management unit that may be configured to determine whether the aerial vehicle is authorized to receive power from the respective power transfer region and to communicate to the communication unit of the transmitter authorization information representative of whether or not the aerial vehicle is authorized to receive power from the respective power transfer region, and the transmitter is configured to receive from the management unit the authorization information.

In some example embodiments, the transmitter of the wireless power transfer system may be configured to increase the power conducted by the respective transmission signal in response to the received authorization information.

In some example embodiments, the transmitter may further be configured to increase the power conducted by the respective transmission signal by an amount proportional to the number of power receivers detected in the respective power transfer region.

In some example embodiments, the transmitter of the wireless power transfer system may further be configured to determine a period of time during which power is transferred to the aerial vehicle.

In some example embodiments, transmitter of the wireless power transfer system may be configured to compare the power being output on the transmission signal and to communicate with the aerial vehicle if the power being output has reached a maximum power output.

In some example embodiments, a method for operating an aerial vehicle may be provided. The method may include flying the aerial vehicle in a magnetic field of a first power transfer region. The method may further include wirelessly receiving first power in a receiver supported by the aerial vehicle from the magnetic field of the first power transfer region. The method may further include at least partially charging with the first power a rechargeable battery used to power the aerial vehicle. The method may further include flying the aerial vehicle from the first power transfer region to a magnetic field of a second power transfer region. Further, the method may include wirelessly receiving second power in the receiver from the magnetic field of the second power transfer region, and at least partially charging the rechargeable battery with the second power. In some example embodiments, the method may further include the aerial vehicle flying from the first power transfer region to the second power transfer region including flying across a non-powering region in which no power is wirelessly received in the receiver.

In some example embodiments, the method may further include that the receiver receives sufficient first power to fly across the non-powering region.

In some example embodiments, the method may further include communicating the indicia identifying the aerial vehicle to a communication unit associated with the first power transfer region.

In some example embodiments, the method may further include communicating the indicia identifying the aerial vehicle to receiving first power.

In some example embodiments, the method may further include receiving from the communication unit, authorization to receive the first power.

In some example embodiments, the method may further include receiving first power upon receipt of the authorization to receive the first power.

In some example embodiments, an aerial vehicle implementing the method described above may be provided.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates an exemplary block diagram of a wireless power transfer system, in accordance with an exemplary embodiment;

FIG. 2 illustrates an exemplary design of a receiver system for wireless power transfer in an aerial vehicle, in accordance with an exemplary embodiment;

FIG. 3 illustrates another exemplary design of a receiver system for wireless power transfer in the aerial vehicle, in accordance with an exemplary embodiment; and

FIG. 4 illustrates an exemplary flow diagram of a method for enabling wireless power transfer in the aerial vehicle, in accordance with an exemplary embodiment.

Accompanying this application is an Annex providing a list of operating variables and values for a sample model of a wireless power network.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention in any form.

Aerial vehicles, specifically unmanned aerial vehicles (UAVs), are a special type of vehicle which may be configured for unmanned flight trajectories. One type of UAVs may include drones which may be used for several applications such as surveillance, aerial supervision, video coverage, photography, data collection and the like. A drone may specifically be used for several consumer and or military applications and may comprise structural components supporting the same.

In some example embodiments, the aerial vehicle, such as a drone may include a rotor assembly having at least one pair of adjacent rotors whose blades, upon rotation, sweep areas that partially overlap each other. The aerial vehicle may also include a power supply that may be configured to supply power for driving the rotor assembly for flight of the aerial vehicle through one or more flying paths.

In some example embodiments, the rotors may each be driven by a separate electrical motor. The rotors may be any kind of rotors such as twin blade rotors, twin-screw rotors and the like. The rotors may have any suitable size as per the requirement, as long as they do not intersect each other. Similarly, the power supply and the electrical motor may be selected as per the requirement.

In some example embodiments, the aerial vehicle may be configured to derive recharge power for the power supply in flight mode through one or more transmitting areas and one or more cells to establish a wireless power transfer system, also interchangeably referred to as wireless power network, for supplying power in flight to the aerial vehicle. In some cases, the aerial vehicle may also land at a specific spot for charging inside a transmitting area, which may also be referred to as a charging area formed by the transmitting antenna. The transmitting areas may be located large distances from each other, such as several or dozens of kilometers. Thus, a cell structure of power areas can be placed to establish a wireless power network for the aerial vehicle, such as a drone.

In some example embodiments, the drone may be configured to fly to any distance within the wireless power transfer system as long as it is being charged over a wireless power transfer region sufficiently to reach a next charging spot.

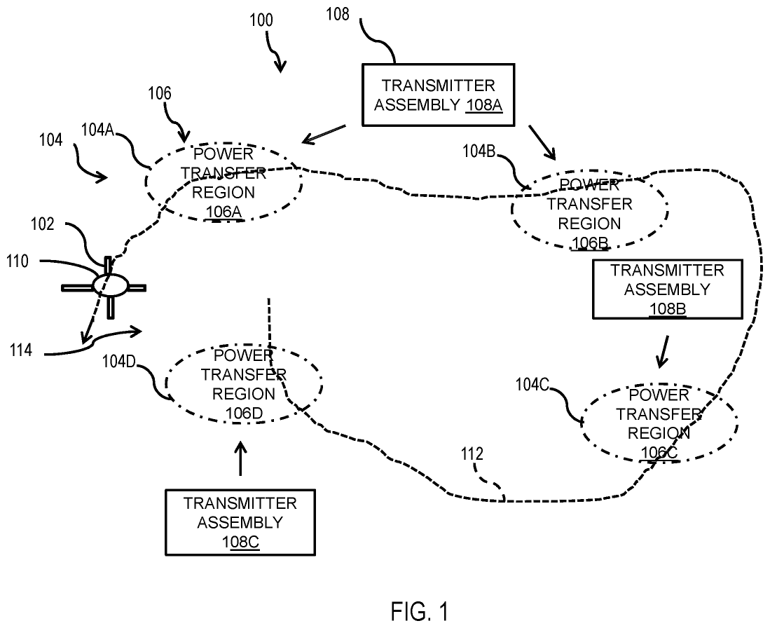

FIG. 1 illustrates an exemplary block diagram of a wireless power transfer system 100, in accordance with an exemplary embodiment. The wireless power transfer system 100 may be a distributed power transfer system through which an aerial vehicle, such as a drone 102, may travel. The wireless power transfer system 100 may include a plurality of cells 104, such as cells 104A, 104B, 104C, and 104D. Each cell may include one or more power transfer regions 106 produced by an associated transmitter assembly 108. For example, power transfer regions 106 of the respective cells include power transfer regions 106A, 106B, 106C, and 106D. A transmitter assembly 108 may produce one or more associated power transfer regions 106. In this example, a transmitter assembly 108A produces power transfer regions 106A and 106B. Transmitter assemblies 108B and 108C produce respective power transfer regions 106C and 106D. Drone 102, having a wireless power receiver 110, may fly from cell to cell, such as along a flight path 112. When the drone 102 is in each power transfer region 106, the drone may store enough power to fly to the next power transfer region. Thus, the cells 104 may form a wireless power network 114 across which drones can travel.

In some example embodiments, the cells 104 may be as far apart as the drones are able to fly on the power received at each cell. The wireless power transfer system 100 and its components as described above have many advantages over the existing art. In preferred configurations, the wireless power transfer system 100 may allow concurrent wireless charging and powering of devices a distance of 10 meters apart in a power transfer region.

In some example embodiments, the wireless power transfer system 100 may also include a system of wires supported in the air a distance above the ground that may serve as an “energy channel”. For example, in case of a long supported wire it may produce a tube-like area around the long wire with typical distance to the wire of 10-20 meters at which such heavy drones may operate or move for an indefinite period of time.

In some example embodiments, within the wireless power transfer system 100, each transmitter assembly 108 may have its own software or hardware key (ID), which may be used by a billing system which may retrieve required parameters of charging session(s) for each ID, such as: received power (determined by voltage and current at each time point), charging session duration, interruption in charging, and the like.

In some example embodiments, the wireless power transfer system 100 may be deployed to a cover specific area or region with a ‘mesh’ formed by charging spots or power transfer regions 106. It could be in cities, specific dedicated areas, industrial objects, as well as temporary covered areas for rescue missions, etc. Such a wireless power transfer system 100 mesh may be accessible to any number of drones (hundreds, thousands, millions), where each charging spot may serve as many drones as possible based on available power. In such a wireless power transfer system 100, each drone may also have its own identification key (ID) to be authorized by the network so that a data channel between transmitter and receiver may be established to optimize and control the charging process.

In some example embodiments, such a wireless power transfer system 100 may be used by UAVs and drones for various applications including but not limited to delivery, passenger moving (urban air transportation), monitoring, filming, security, performing a rescue mission, and the like. In such embodiments, the same wireless power transfer system 100 may be used for manned and unmanned aerial vehicles, including flying vehicles, UAVs, and drones.

In some example embodiments, the aerial vehicles, such as drones 102, may have a specific design for receiving antennas or a receiver system.

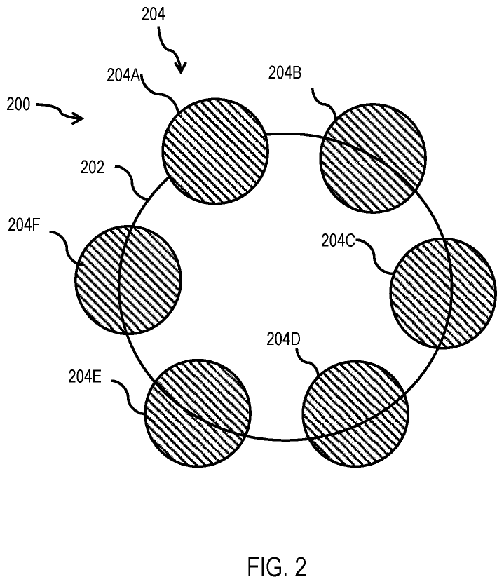

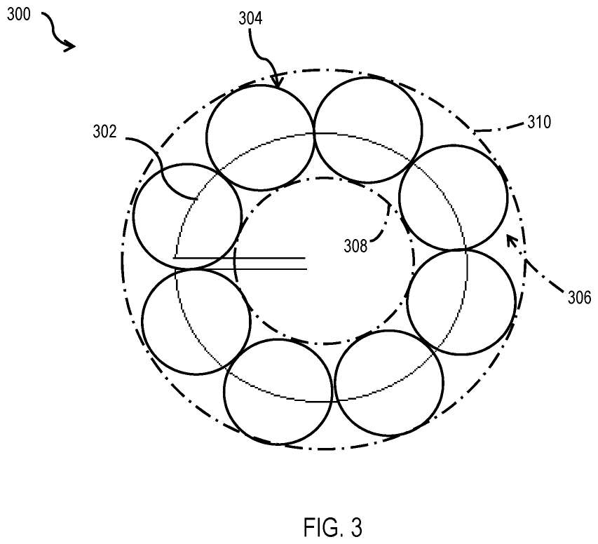

FIG. 2 illustrates an exemplary design of a receiver system 200 for wireless power transfer in an aerial vehicle, such as in the drone 102. The receiver system 200 may include a receiving antenna 202 that may be placed as a loop extending along a rotor assembly 204 including the rotors producing rotor-blade trajectories represented by circles 204A-204F. In the example embodiment of FIG. 2, 30%-90% of the perimeter of the receiving antenna 202 may overlap the blade trajectories 204A-204F when viewed from above or normal to the planes of the blade trajectories. In some other examples, other configurations of the receiving antenna 202 and the rotor assembly 204 may be possible. For example, FIG. 3 illustrates an alternate embodiment of the receiver system.

FIG. 3 illustrates another exemplary design of a receiver system 300 for wireless power transfer in the aerial vehicle 102. The receiver system 300 may include multiple blade trajectories 304 distributed around a center of the receiver system. In such a configuration, the blade trajectories 304 are positioned in a band 306 of rotors bounded between an inner hypothetical circle 308 and an outer hypothetical circle 310. A receiving antenna 302 is preferably positioned over and at least partially in alignment with band 306. Preferably, at least 70% of receiving antenna 302 may be located in alignment with band 306.

In a similar manner, many different ways to define the location and geometry of the receiving antenna may be possible and the examples depicted in FIGS. 2 and 3 are for illustration purpose only and are not intended to limit the scope of the invention to these two configurations only.

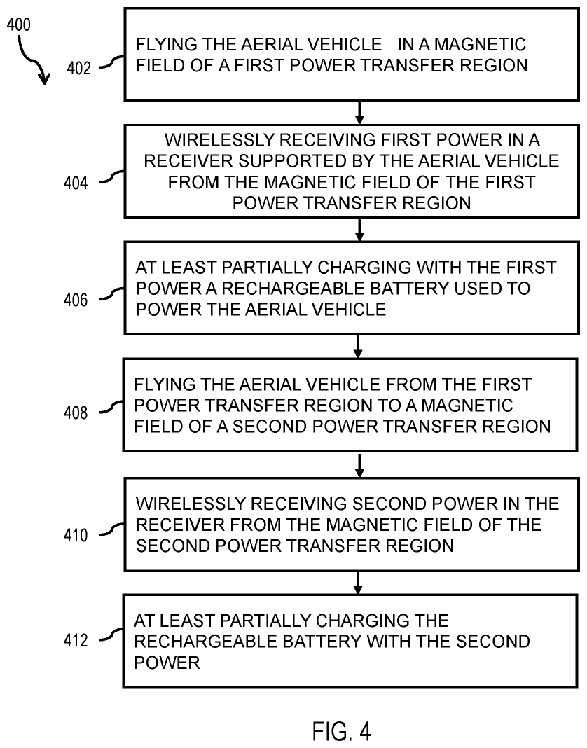

It may be understood that irrespective of the receiving antenna configuration, the aerial vehicle 102 may be configured to leverage the advantages of flight or landing based charging using the wireless power transfer system 100. The charging of the aerial vehicle 102 may be illustrated by a method depicted in FIG. 4 as follows.

FIG. 4 illustrates an exemplary flow diagram of a method 400 for enabling wireless power transfer in the aerial vehicle 102 using the wireless power transfer system 100. The method 400 may include, at step 402, flying the aerial vehicle 102 within a magnetic field region of a first power transfer region. For example, the aerial vehicle 102 may fly within the range of the cell 104A associated with the power transfer region 106A illustrated in FIG. 1. Within that region, the aerial vehicle 102 may be configured to, at step 404, wirelessly receive first power in a receiver supported by the aerial vehicle 102 from the magnetic field of the first power transfer region. The receiver supported by the aerial vehicle may have any configuration if the receiving assembly, such as illustrated in FIGS. 2 and 3 discussed earlier. The receiving of the power may enable the aerial vehicle to, at step 406, at least partially charge the first power a rechargeable battery used to power the aerial vehicle 102.

Further, the aerial vehicle 102 may be enabled to, at step 408, fly from the first power transfer region to a magnetic field of the second power transfer region due to the partial charging of the rechargeable battery used in the aerial vehicle.

Once the aerial vehicle 102 flies to the second power transfer region, such as the cell 104B associated with the power transfer region 106B, at step 410, the aerial vehicle 102 may receive second power in the receiver from the magnetic field of the second power transfer region. Further, at step 412, this second power may enable at least partially recharging the rechargeable battery of the aerial vehicle. Thus, using the method 400, the aerial vehicle 102 may configured to successively charge its rechargeable battery for successive flights between power transfer regions or charging spots.

In some example embodiments, the aerial vehicle 102 may include a communication system that may be configured to interact with a flight controller module. The interaction may enable precise hovering and an optimized charging experience, as a ground station (or transmitter) may be controlling drone flight parameters during the charging session.

The interaction between the communication system and the flight controller module may be configured to implement some or all of the steps of the method 400 discussed above. For example, when the aerial vehicle 102 approaches a power transfer region, also interchangeably referred to herein as a charging area or charging spot, it may request a charging session from the ground station via a data channel. The aerial vehicle may be at some proximity in an area comparable with the size of the transmitter at any location in the power transfer region, at the time of making such a request. Further, if the ground station recognizes the aerial vehicle and approves the charging session, it may send a request to take over flight control of the aerial vehicle by the ground station or transmitter. Further, if the aerial vehicle accepts the transfer of flight control to the ground station, it may send a confirmation command to initiate the charging session. Once the ground station receives the confirmation of flight control, it may intercept the aerial vehicle flight control via an integrated onboard command module and start flying the aerial vehicle 102 to move the aerial vehicle to a certain position within the charging area that is determined to be best for the particular aerial vehicle 102 relative to other aerial vehicles that may also be charging in the charging area. Further, once the charging is completed, the ground station may move the aerial vehicle 102 outside of the charging area and send a command to aerial vehicle's flight system that it can take back control over flight parameters and continue its mission. Thus, the interaction between the communication system and the flight controller may be done to carry out the method 400 in accordance with an exemplary embodiment.

In an example embodiment, an apparatus for performing the method 400 of FIG. 4 above may comprise a processor configured to perform some or each of the operations of the method of FIG. 4 described previously. The processor may, for example, be configured to perform the operations (402-412) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (402-412) may comprise, for example, the processor which may be implemented as a separate module in the aerial vehicle 102 and/or a device or circuit for executing instructions or executing an algorithm for processing information as described above.

In some example embodiments, the aerial vehicle 102 may be configured to perform “on demand” charging using a triangular grid of power transfer regions in a wireless power transfer system. The on-demand charging may enable the aerial vehicle 102 to perform automatic charging if the aerial vehicle stays in or close to the triangular grid.

In some example embodiments, the power transfer regions may be evenly distributed, such as within 10-20 meters of each other in a region of flight for the aerial vehicle.

In some example embodiments, the power transfer regions may be associated with one or more billing and authorization of receivers that may be coupled to a billing database containing information about authorized receivers. The billing database may also be configured to manage grid loading and routing of aerial vehicles.

In some example embodiments, the power transfer regions and aerial vehicles may be connected by a data channel which may be configured to provide authorization for wireless power transfer. The data channel may be implemented such as a direct link, a radio channel and the like.

The power transfer system discussed in the methods and systems disclosed herein may be configured to provide an advantage of using wireless recharging of aerial vehicles over short distance to enable continuous uninterrupted flight operation.

The methods and systems set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

What is claimed:

1. A wireless power transfer system comprising:
at least one transmitter generating at least one transmission signal;
a plurality of transducers each conducting a respective transmission signal of the at least one transmission signal, the plurality of transducers being positioned at respective different locations for producing from the respective transmission signals magnetic fields defining associated power transfer regions for transmitting wirelessly with the associated magnetic fields power to aerial vehicles located in the power transfer regions.

2. The system of claim 1, wherein at least two of the power transfer regions are spaced apart from each other.

3. The system of claim 2, wherein the at least two adjacent power transfer regions are spaced at least one kilometer apart.

4. The system of claim 2, wherein at least three of the power transfer regions are spaced apart from each other.

5. The system of claim 4, wherein the at least three power transfer regions are distributed to form a two-dimensional grid of power transfer regions.

6. The system of claim 2, wherein at least two of the power transfer regions overlap forming an extended power transfer region.

7. The system of claim 4, wherein a chain of at least three of the power transfer regions overlap end to end to form the extended power transfer region as a linear extended power transfer region.

8. The system of claim 1, further comprising a management unit maintaining information regarding operation and use of the power transfer regions, and wherein each of the at least one transmitter includes a communication unit configured to communicate with the management unit and with the aerial vehicles located in the associated one or more of the power transfer regions having magnetic fields produced by the respective transmission signals generated by the transmitter.

9. The system of claim 8, wherein each transmitter is configured to receive from each aerial vehicle in associated indicia identifying the aerial vehicle and communicate the received indicia identifying the aerial vehicle to the management unit.

10. The system of claim 9, wherein the management unit is configured to determine whether the aerial vehicle is authorized to receive power from the respective power transfer region and to communicate to the communication unit of the transmitter authorization information representative of whether or not the aerial vehicle is authorized to receive power from the respective power transfer region, and the transmitter is configured to receive from the management unit the authorization information.

11. The system of claim 10, wherein the transmitter is further configured to increase the power conducted by the respective transmission signal in response to the received authorization information.

12. The system of claim 11, wherein the transmitter is configured to increase the power conducted by the respective transmission signal by an amount proportional to the number of power receivers detected in the respective power transfer region.

13. The system of claim 12, wherein the transmitter is configured to determine a period of time during which power is transferred to the aerial vehicle

14. The system of claim 9, wherein the management unit is configured to determine whether or not the identifying indicia is included in a list of identifying indicia for power receivers authorized to receive power in the power transfer region.

15. The system of claim 8, wherein the transmitter is configured to compare the power being output on the transmission signal and to communicate with the aerial vehicle if the power being output has reached a maximum power output.

16. A method of operating an aerial vehicle, comprising:
flying the aerial vehicle in a magnetic field of a first power transfer region;
wirelessly receiving first power in a receiver supported by the aerial vehicle from the magnetic field of the first power transfer region;
at least partially charging with the first power a rechargeable battery used to power the aerial vehicle;
flying the aerial vehicle from the first power transfer region to a magnetic field of a second power transfer region;
wirelessly receiving second power in the receiver from the magnetic field of the second power transfer region; and
at least partially charging the rechargeable battery with the second power.

17. The method of claim 16, wherein flying from the first power transfer region to the second power transfer region includes flying across a non-powering region in which no power is wirelessly received in the receiver.

18. The method of claim 17, wherein the receiver receives sufficient first power to fly across the non-powering region.

19. The method of claim 16, further comprising communicating indicia identifying the aerial vehicle to a communication unit associated with the first power transfer region.

20. The method of claim 19, wherein communicating indicia identifying the aerial vehicle is prior to receiving first power.

21. The method of claim 19, further comprising receiving from the communication unit authorization to receive the first power.

22. The method of claim 21, wherein receiving first power is performed only upon receipt of the authorization to receive the first power.
